(19) United States
(12) Patent Application Publication
(10) Pub. No.: US 2012/0103428 A1
(43) Pub. Date: May 3, 2012

(54) VAPORIZATION CHAMBERS AND ASSOCIATED METHODS

(75) Inventors: Terry D. Turner, Idaho Falls, ID (US); Bruce M. Wilding, Idaho Falls, ID (US); Michael G. McKellar, Idaho Falls, ID (US); Lee P. Shunn, Idaho Falls, ID (US)

(73) Assignee: BATTELLE ENERGY ALLIANCE, LLC, Idaho Falls, ID (US)

(21) Appl. No.: 12/938,761

(22) Filed: Nov. 3, 2010

(51) Int. Cl. F17D 1/18

(52) U.S. Cl. 137/13; 422/243

(57) ABSTRACT

A vaporization chamber may include at least one conduit and a shell. The at least one conduit may have an inlet at a first end, an outlet at a second end and a flow path therebetween. The shell may surround a portion of each conduit and define a chamber surrounding the portion of each conduit. Additionally, a plurality of discrete apertures may be positioned at longitudinal intervals in a wall of each conduit, each discrete aperture of the plurality of discrete apertures sized and configured to direct a jet of fluid into each conduit from the chamber. A liquid may be vaporized by directing a first fluid comprising a liquid into the inlet at the first end of each conduit, directing jets of a second fluid into each conduit from the chamber through discrete apertures in a wall of each conduit and transferring heat from the second fluid to the first fluid.

### CROSS-REFERENCE TO RELATED APPLICATIONS

The present application is related to co-pending U.S. patent application Ser. No. 11/855,071 filed on Sep. 13, 2007, titled HEAT EXCHANGER AND ASSOCIATED METHODS, co-pending U.S. patent application Ser. No. ______, filed on an even date herewith, titled “HEAT EXCHANGER AND RELATED METHODS,” attorney docket number BA-495 (2939-10081 US); and co-pending U.S. patent application Ser. No. ______, filed on an even date herewith, titled “SUBLIMATION SYSTEMS AND ASSOCIATED METHODS,” attorney docket number BA-496 (2939-10082US), the disclosure of each which application is incorporated by reference herein in its entirety.

### GOVERNMENT RIGHTS

This invention was made with government support under Contract Number DE-AC07-05ID14517 awarded by the United States Department of Energy. The government has certain rights in the invention.

### TECHNICAL FIELD

The invention relates generally to vaporization chambers and methods associated with the use thereof. More specifically, embodiments of the invention relate to vaporization chambers including a conduit with discrete apertures formed therein. Embodiments of the invention additionally relates to the methods of heat transfer between fluids, the vaporization of liquids within a fluid mixture, and the conveyance of fluids.

### BACKGROUND

The production of liquefied natural gas is a refrigeration process that reduces the mostly methane (CH₄) gas to a liquid state. However, natural gas consists of a variety of gases in addition to methane. One of the gases contained in natural gas is carbon dioxide (CO₂). Carbon dioxide is found in quantities around 1% in most of the natural gas infrastructure found in the United States, and in many places around the world the carbon dioxide content is much higher.

Carbon dioxide can cause problems in the process of natural gas liquefaction, as carbon dioxide has a freezing temperature that is higher than the liquefaction temperature of methane. The high freezing temperature of carbon dioxide relative to methane will result in solid carbon dioxide crystal formation as the natural gas cools. This problem makes it necessary to remove the carbon dioxide from the natural gas prior to the liquefaction process in traditional plants. The filtration equipment to separate the carbon dioxide from the natural gas prior to the liquefaction process may be large, may require significant amounts of energy to operate, and may be very expensive.

Small scale liquefaction systems have been developed and are becoming very popular. In most cases, these small plants are simply using a scaled down version of existing liquefaction and carbon dioxide separation processes. The Idaho National Laboratory has developed an innovative small scale liquefaction plant that eliminates the need for expensive, equipment intensive, pre-cleanup of the carbon dioxide. The carbon dioxide is processed with the natural gas stream, and during the liquefaction step the carbon dioxide is converted to a crystalline solid. The liquid/solid slurry is then transferred to a separation device which directs a clean liquid out of an overflow, and a carbon dioxide concentrated slurry out of an underflow.

The underflow slurry is then processed through a heat exchanger to sublime the carbon dioxide back into a gas. In theory this is a very simple step. However, the interaction between the solid carbon dioxide and liquid natural gas produces conditions that are very difficult to address with standard heat exchangers. In the liquid slurry, carbon dioxide is in a pure or almost pure sub-cooled state and is not soluble in the liquid. The carbon dioxide is heavy enough to quickly settle to the bottom of most flow regimes. As the settling occurs, piping and ports of the heat exchanger can become plugged as the quantity of carbon dioxide builds. In addition to collecting in undesirable locations, the carbon dioxide has a tendency to clump together making it even more difficult to flush through the system.

The ability to sublime the carbon dioxide back into a gas is contingent on getting the solids past the liquid phase of the gas without collecting and clumping into a plug. As the liquid natural gas is heated, it will remain at approximately a constant temperature of about −230° F. (at 50 psig) until all the liquid has passed from a two-phase gas to a single-phase gas. The solid carbon dioxide will not begin to sublime back into a gas until the surrounding gas temperatures have reached approximately −80° F. While the solid carbon dioxide is easily transported in the liquid methane, the ability to transport the solid carbon dioxide crystals to warmer parts of the heat exchanger is substantially diminished as liquid natural gas vaporizes. At a temperature when the moving, vaporized natural gas is the only way to transport the solid carbon dioxide crystals, the crystals may begin to clump together due to the tumbling interaction with each other, leading to the aforementioned plugging.

In addition to clumping, as the crystals reach warmer areas of the heat exchanger they begin to melt or sublime. If melting occurs, the surfaces of the crystals becomes sticky, causing the crystals to have a tendency to stick to the walls of the heat exchanger, reducing the effectiveness of the heat exchanger and creating localized fouling. The localized fouling areas may cause the heat exchanger may become occluded and eventually plug if fluid velocities cannot dislodge the fouling.

In view of the shortcomings in the art, it would be advantageous to provide a vaporization chamber and associated methods that would enable the effective and efficient vaporization of liquid therein and the efficient transfer of solid carbon dioxide to a sublimation device.

### BRIEF SUMMARY

In accordance with one embodiment of the invention a vaporization chamber may include at least one conduit and a shell. The at least one conduit may have an inlet at a first end, an outlet at a second end and a flow path therebetween. The shell may surround a portion of the conduit and define a chamber surrounding the portion of the conduit. Additionally, a plurality of discrete apertures may be positioned at longitudinal intervals in a wall of the conduit, each aperture of the plurality of discrete apertures sized and configured to direct a jet of fluid into the conduit from the chamber.

In accordance with another embodiment of the invention, a method is provided for vaporizing a liquid by directing a first fluid comprising a liquid into an inlet at a first end of the conduit, directing jets of a second fluid into the conduit from a chamber surrounding a portion of the conduit through discrete apertures in a wall of the conduit and transferring heat from the second fluid to the first fluid. Additionally, a mixture comprising the first fluid and the second fluid may be directed through an outlet at a second end of the conduit.

### BRIEF DESCRIPTION OF THE DRAWINGS

FIG. 1A depicts a longitudinal cross-sectional detail view of a vaporization chamber according to an embodiment of the present invention.

FIG. 1B depicts a transverse cross-sectional detail view of the vaporization chamber of FIG. 1A.

FIG. 2 depicts a longitudinal cross-sectional detail view of a vaporization chamber including apertures having a perpendicular orientation according to an embodiment of the present invention.

FIG. 3A depicts a transverse cross-sectional view of a conduit for vaporization chamber according to an embodiment of the present invention, the conduit having apertures in an annular arrangement.

FIG. 3B depicts a longitudinal cross-sectional detail view of the conduit of FIG. 3A.

FIG. 4A depicts a transverse cross-sectional view of a conduit for vaporization chamber according to an embodiment of the present invention, the conduit having apertures in a helical arrangement.

FIG. 4B depicts a longitudinal cross-sectional detail view of the conduit of FIG. 4A.

FIG. 5A depicts an isometric partial cutaway view of a vaporization chamber having a conduit with elbows according to an embodiment of the present invention.

FIG. 5B depicts an isometric view of the conduit of the vaporization chamber of FIG. 5A.

FIG. 5C depicts a detail view of an aperture of the conduit of FIG. 5B.

FIG. 6 depicts a longitudinal cross-sectional view of a vaporization chamber that includes multiple conduits according to an embodiment of the present invention.

FIG. 7 depicts a longitudinal cross-sectional view of a vaporization chamber that includes a conduit having a stepped taper according to an embodiment of the present invention.

FIG. 8 depicts a longitudinal cross-sectional view of a vaporization chamber that includes a conduit having a substantially continuous taper according to an embodiment of the present invention.

### DETAILED DESCRIPTION

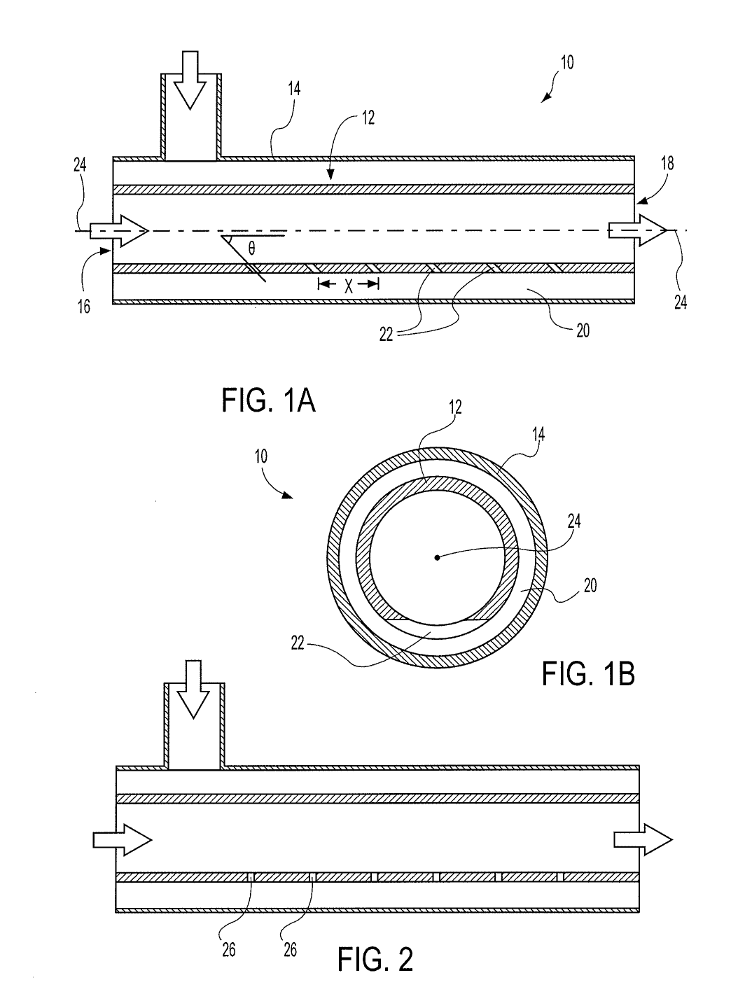

FIG. 1A shows a cross-sectional detail view of a vaporization chamber 10 according to an embodiment of the present invention. It is noted that, while operation of embodiments of the present invention is described in terms of the vaporization of liquid natural gas carrying a solid carbon dioxide in the processing of natural gas, the present invention may be utilized for the vaporization, sublimation, heating, cooling, and mixing of other fluids and for other processes, as will be appreciated and understood by those of ordinary skill in the art.

The term “fluid” as used herein means any substance that may be caused to flow through a conduit and includes, but is not limited to, gases, two-phase gases, liquids, gels, plasmas, slurries, solid particles, and any combination thereof.

As shown in FIG. 1, the vaporization chamber 10 may include at least one conduit 12 extending through a shell 14. The conduit 12 may have an inlet 16 at a first end, an outlet 18 at a second end and a flow path therebetween. The shell 14 may surround at least a portion of the conduit 12 and define a chamber 20 around the portion of conduit 12. In some embodiments, the conduit 12 may be coaxial with the shell 14, as shown in FIG. 1B. However, in additional embodiments, a conduit may be directed through any portion of a shell. Additionally, the conduit 12 may include a plurality of discrete apertures 22 positioned at longitudinal intervals in a wall of the conduit 12, each aperture 22 of the plurality of discrete apertures 22 may be sized and configured to direct a relatively high velocity jet of fluid (e.g., heated gas) into the flow path of the conduit 12 from the chamber 20.

Each aperture 22 may be positioned at an angle θ with respect to a longitudinal axis 24 of the conduit 12. For example, as shown in FIG. 1, each aperture 22 may be positioned at an acute angle θ (i.e., an angle less than 90°) with respect to the longitudinal axis 24 of the conduit 12. As a non-limiting example, each aperture 22 may be positioned at an angle θ of about forty-five degrees (45°) with respect to the longitudinal axis 24 of the conduit 12. This may allow a jet of fluid to be directed into the conduit 12 from the chamber 20 through an aperture 22 at a direction that opposes the average flow direction of fluid through the conduit 12. In additional embodiments, apertures 26 may be positioned perpendicular to the longitudinal axis of the conduit, as shown in FIG. 2, or may be positioned at another angle relative to the longitudinal axis of the conduit. Referring again to FIG. 1A, in some embodiments, each of the apertures 22 may be positioned at the same angle θ relative to the longitudinal axis 24 of the conduit 12. In additional embodiments, the apertures 22 may be positioned at various angles relative to the longitudinal axis 24 of the conduit 12, and at different angles with respect to other apertures 22 of the conduit 12. For example, the relative angle θ of the apertures 22 may vary with respect to their longitudinal or circumferential position relative to the conduit 12 (not shown).

The plurality of apertures 22 may be spaced at longitudinal intervals along the length of the conduit 12, such as shown in FIG. 1A. Each aperture 22 may be spaced longitudinally a distance X from another aperture 22 in the conduit 12. This spacing may allow a recirculation effect between the longitudinally spaced apertures 22 of the conduit 12. For example, the spacing may be selected utilizing computational fluid dynamics (CFD) simulations to increase the maximum residence time of fluid within the vaporization chamber 10, which may result in a more complete vaporization of a liquid component of the fluid. In some embodiments, the spacing distance X between the apertures 22 may be constant, and the apertures 22 may be evenly distributed along the length of the conduit 12. In additional embodiments, the spacing distance X may vary along the length of the conduit 12. For example, the spacing distance X between the apertures 22 may increase along the length of the conduit 12.

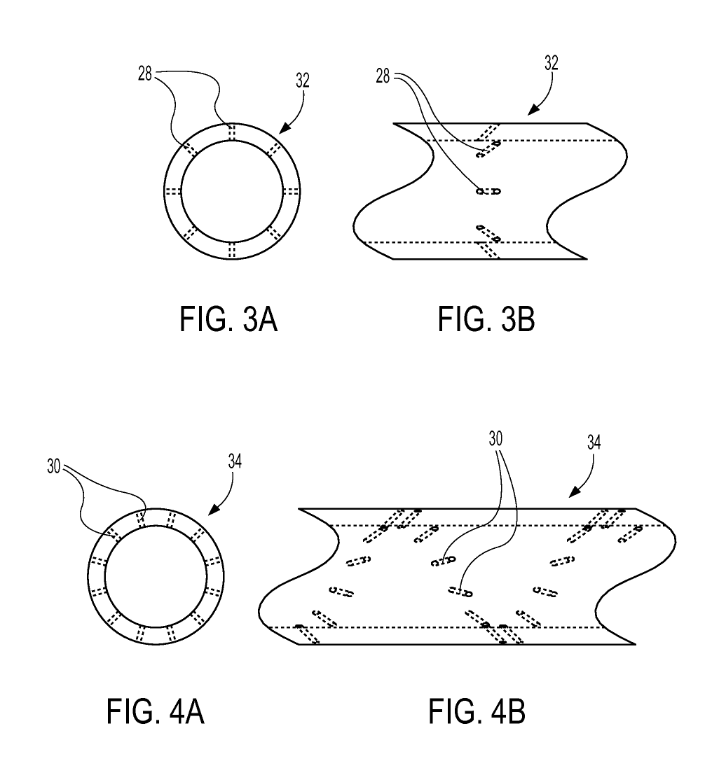

In some embodiments, such as shown in FIGS. 1A and 1B, the apertures 22 may be positioned solely or primarily along the bottom of the conduit 12, which may assist in distributing denser components of the fluid throughout the conduit 12, as denser components may tend to move toward the bottom of the conduit 12 due to gravity. In additional embodiments, apertures 28, 30 may be spaced circumferentially in the wall of the conduit 32, 34 as shown in FIGS. 3A, 3B, 4A and 4B. For example, as shown in FIG. 3B, the apertures 28 may be spaced circumferentially along the wall of the conduit 32 at longitudinal intervals in annular arrangements. In another example, as shown in FIG. 4B, each aperture 30 may be spaced circumferentially and longitudinally from an adjacent aperture 30 and be positioned along the wall of the conduit 34 in a spiral arrangement (i.e., a helical arrangement).

Referring to FIGS. 1A and 1B, the size of apertures 22 may be relatively small in comparison to the size of the conduit 12. For example, the cross-sectional area of an opening of an aperture 22 may be less than about 1/100 the size of the cross-sectional area of the conduit 12. Additionally, the shape of the apertures 22 may be selected according to the jet configuration desired. In some embodiments, such as shown in FIGS. 1A and 1B, the apertures 22 may be configured as slots cut into the wall of the conduit 12 to provide fan-shaped jets. In additional embodiments, such as shown in FIGS. 3A, 3B, 4A and 4B, the apertures 28, 30 may be configured as cylindrical openings formed in the wall of the conduit 32, 34 to provide one of generally cylindrical-shaped jets and generally frustoconical-shaped jets, depending on fluid pressure differences, relative fluid densities and other fluid conditions. In further embodiments, apertures having other shapes and combinations of apertures having various shapes may be provided in the wall of a conduit, the shape of each aperture selected to provide a specific jet pattern. The apertures 22, 26, 28, 30 may be formed in the conduit 12, 32, 34 by any number of machining techniques, including, but not limited to, wire electrical discharge machining (EDM), sinker EDM, electrochemical machining (ECM), laser-beam machining, electron-beam machining (EBM), water jet machining, abrasive jet machining, plasma cutting, milling, sawing, punching and drilling.

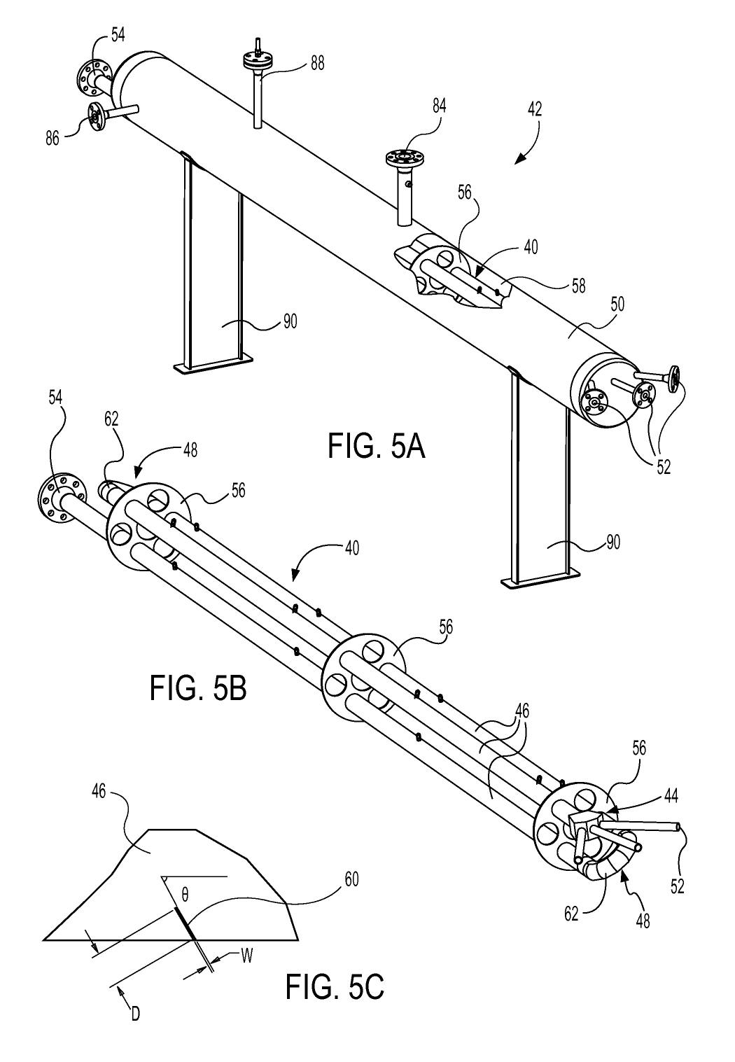

As shown in FIGS. 5A-5C, a conduit 40 of a vaporization chamber 42 may be configured with an inlet manifold 44 to receive fluid from a plurality of fluid sources into the conduit 40. The conduit 40 may additionally include a plurality of lengths of pipe 46 connected with elbows 48 to allow for a reduced overall length of a surrounding shell 50. Each length of pipe 46 of the conduit 40 may be positioned below a previous length of pipe 46 of the conduit 40, respectively, from an inlet 52 to an outlet 54. The conduit 40 may be supported within the shell 50 by a support structure, such as a plurality of support plates 56, that may maintain the position of the conduit 40 relative to the shell 50 and that may allow the flow of fluid in a chamber 58 therepast. Each length of pipe 46 may have a solid wall, with the exception of discrete apertures 60 formed along the length thereof, and each elbow 48 may include a porous wall 62.

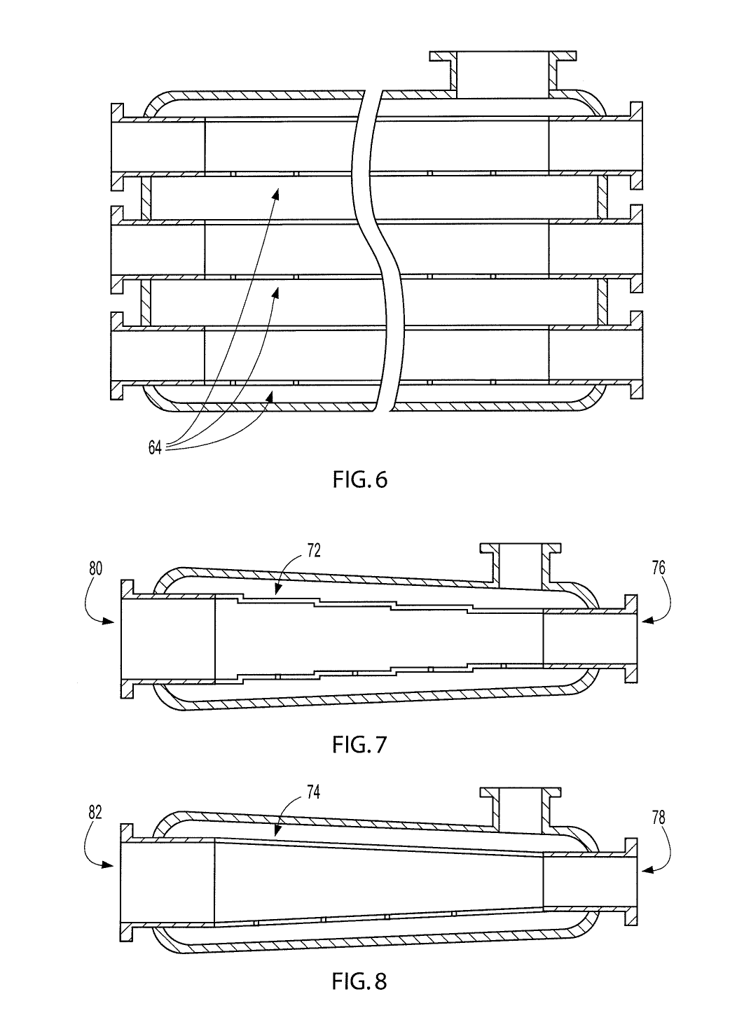

Forming the conduit 40 with one or more elbows 48, as shown in FIG. 5B, and/or employing a plurality of conduits 64, as shown in FIG. 6, may allow flexibility in the manufacture of a vaporization chamber. The flexibility in manufacture may facilitate flexibility in the size and shape of a vaporization chamber as well as flexibility in the locations of inlets and outlets. This may facilitate the manufacture of a vaporization chamber to fit within a limited floor space and may allow for an efficient flow design for a processing plant incorporating such a vaporization chamber.

In additional embodiments, vaporization chambers may be configured with a conduit that has a varying cross sectional area, as shown in FIGS. 7 and 8. For example, as shown in FIG. 7, a conduit 72 may comprise a pipe that is step-tapered, having an internal cross-sectional area near an inlet end 76 smaller than an internal cross-sectional area near an outlet end 80. For another example, as shown in FIG. 8, a conduit 74 may comprise a pipe that is continuously tapered, having an internal cross-sectional area near an inlet end 78 smaller than an internal cross-sectional area near an outlet end 82.

The cross-sectional area of a conduit may affect flow conditions within the conduit. For example, as shown in FIG. 1A, as fluid enters the conduit 12 from the chamber 20 through the apertures 22, the mass flow rate through the conduit 12 will increase along the length of the conduit 12. If the cross-sectional area of the conduit 12 remains constant as the mass flow rate increases the velocity of the flow will increase (assuming that there is little additional compression of the fluid). As shown in FIGS. 7 and 8, if it is desired to control the flow velocity within the conduit 72, 74 the cross-sectional area of the conduit 72, 74 may be varied along its length to affect the flow velocity. For example, the cross-sectional area of the conduit 72, 74 may be increased along its length such that the velocity of the flow may be relatively constant throughout the conduit 72, 74. Likewise, if higher flow velocities are desired as the fluid flows through a conduit, the cross-sectional area of the conduit may be decreased along its length.

Referring again to FIGS. 5B, the configuration and orientation of the lengths of pipe 46 of the conduit 40 may affect the flow of the fluid therethrough, especially if the fluid contains solid particles, such as solid carbon dioxide. The particles may be drawn downward by gravity, and so it may be desirable to orient each length of pipe 46 such that the fluid flow through the lengths of pipe 46 is mostly horizontal. A horizontally oriented flow may cause solid particles to be conveyed within the lengths of pipe 46 at a velocity similar to the gases and/or liquids within which the solid particles are suspended.

Referring the FIG. 5A, the surrounding shell 50 may have a shape selected for pressurization, such as a generally cylindrical shape, and may include a plurality of openings therethrough for the passage of inlets 52, 84, outlets 54, 86, and instrumentation ports 88. Each opening in the shell 50 may be sealed to a conduit extending therethrough, such as by a weld, to allow the chamber 58 to be pressurized. Additionally, a support structure, such as legs 90, may be attached to the shell 50.

As shown in FIG. 5A, inlets 52 to the conduit 40 may pass through a first end of the shell 50, and an outlet 54 from the conduit 40 may pass through a second end of the shell 50. A fluid inlet 84 to the chamber 58 may be positioned near a center of the shell 50 and a fluid outlet 86 from the chamber 58 may be positioned near the second end of the shell 50, proximate to the outlet 54 from the conduit 40. Additionally, an instrumentation port 88 may extend through the shell 50 to provide communication access for instrumentation within the shell 50; such as temperature sensors, pressure sensors, etc.

When used in conjunction with a natural gas liquefaction plant, such as described in U.S. Pat. No. 6,962,061 to Wilding et al., the disclosure of which is incorporated herein in its entirety by reference, the inlets 52 to the conduit 40 may be coupled to an underflow outlet of one or more hydrocyclones. The outlet 54 of the conduit 40 may be coupled to an inlet of a sublimation device, such as described in co-pending U.S. patent application Ser. No. ______, filed on an even date herewith, titled “HEAT EXCHANGER AND RELATED METHODS,” attorney docket number BA-495 (2939-10081 US); and co-pending U.S. patent application Ser. No. ______, filed on an even date herewith, titled “SUBLIMATION SYSTEMS AND ASSOCIATED METHODS,” attorney docket number BA-496 (2939-10082US, the disclosures of each of which are previously incorporated herein. The inlet 84 of the chamber 58 may be coupled to a gaseous natural gas stream and the gas from the outlet 86 may be redirected into the natural gas liquefaction plant, may be directed into a natural gas pipeline, may be combusted, such as by a torch or a power plant, or otherwise directed from the chamber 58. In additional embodiments, no outlet may be included, or the outlet 86 may be capped, such as by a blind flange, and all of the gas directed into the vaporization chamber 42 may be directed out of the outlet 54 of the conduit 40.

In operation, a first fluid, such as a slurry comprising liquid natural gas and crystals of solid carbon dioxide precipitate, may be directed into an inlet 52 of the conduit 40. As the first fluid flows through the conduit 40, the heavier portions of the first fluid may tend to move to the bottom of the flow regime due to gravity. In view of this, the first fluid flow may naturally tend to stratify, with the denser portions (i.e., the liquid and solid portions) settling to the bottom and the less dense portions (i.e., gaseous portions) flowing over the denser portions of the first fluid.

As the first fluid is directed into the inlet 52 of the conduit 40, a second fluid, such as relatively warm natural gas, may be directed into the inlet 84 of the chamber 58 within the shell 50. As the first fluid flows through the conduit 40, the second fluid is directed into the conduit 40 through the apertures 60 from the surrounding chamber 58. In view of this, the relatively warm second fluid may transfer heat through the solid wall of the conduit 40 to the first fluid, and the second fluid may transfer heat to the first fluid through direct mixing within the conduit 40. The flow of the second fluid through the apertures 60 may be induced by a pressure gradient between the chamber 58 and the interior of the conduit 40. For example, the pressure inside of the conduit 40 may be about 1-50 psi less than the pressure of the chamber 58. In one example the pressure inside the conduit 40 may be about 5 psi less than the pressure of the chamber 58. As the second fluid is directed into the conduit 40 in individual jets through the discrete apertures 60, the liquid portions of the first fluid may be broken up, such as into droplets and mixed with the gaseous portions of the fluid within the conduit 40. Additionally, the jets of second fluid may create turbulence in the fluid flow through the conduit 40, which may cause mixing and inhibit flow stratification. The breaking up of the liquid portions of the first fluid, such as into droplets, may increase the surface are of the liquid and promote vaporization. Additionally, the turbulence and mixing generated by the jets through the apertures 60 may also promote heat transfer from the second fluid to the first fluid and promote vaporization.

As the first fluid is directed through the conduit 40, the apertures 60 directing jets of second fluid into the conduit 40 may be positioned at longitudinal distances that are optimized to create recirculation zones in the flow through the conduit 40. Additionally, the angle θ of the apertures 60 may be selected to create jets that are directed upstream, relative to the average flow direction through each length of pipe 46 of the conduit 40, which may increase turbulence and break up the liquid portions of the first fluid.

Any elbows 48 used to change the direction of the flow as it travels through the conduit 40 may comprise a porous wall 62. The porous wall 62 may allow the second fluid to flow through the porous wall 62 and create a boundary layer of warm fluid near the inner wall of the elbow 48, which may prevent solids in the fluid flow from sticking the walls of the elbows 48 as the fluid flow changes direction.

If, for example, carbon dioxide crystals were to adhere to a portion of the porous wall 62 the continuous flow of the heated first fluid through the porous wall 62 may heat the carbon dioxide crystals that adhere to the porous wall 62. The heating of the carbon dioxide crystals will result in the melting or sublimation of the crystals, which may cause the crystals to release from the porous wall 62 or cause the carbon dioxide to fully transition to a gaseous form. This may reduce the amount of localized fouling that may occur within the conduit 40 at a given time, and may allow the first fluid to continuously flow through the conduit 40 during the operation of the vaporization chamber 42. Additionally, portions of the interior wall, or the entire interior wall, of the conduit 40 may be polished to inhibit the adhesion of solids thereto.

The temperature of the second fluid may be selected to be above the vaporization temperature of the liquid portion of the first fluid (i.e., above the vaporization temperature of methane) and, upon mixing with the first fluid, to be below the sublimation temperature of a solid portion of the first fluid (i.e., below the sublimation temperature of carbon dioxide). In view of this, the liquid portion of the first fluid may be substantially vaporized and the mixture of the first fluid and second fluid that is directed out of the conduit 40 may be substantially free of a liquid phase and may consist essentially of a solid phase (i.e., solid carbon dioxide) suspended in a gaseous phase (i.e., gaseous natural gas).

### Example Embodiment

In one embodiment, as shown in FIGS. 5A-5C, a conduit 40 includes three lengths of two-inch nominal size, Schedule 10 (2.375 inch outer diameter; 2.157 inch inner diameter; 60.33 mm outer diameter; 54.79 mm inner diameter), stainless-steel pipe 46, according to the American National Standards Institute (ANSI) and the American Society of Mechanical Engineers (ASME) standard ANSI/ASME 36.19M. Each length of pipe 46 is about 160 inches (about 406 cm) and includes eight aperatures 60 formed as slots therein. Each aperture 60 is spaced about 28 inches (about 71 cm) from another aperture 60 and positioned at the bottom of a length of the stainless-steel pipe 46. As shown in FIG. 5C, each slot, having a width W of about 0.015 inches (about 0.38 mm), has a depth D of about 0.313 inches (about 7.95 mm) at an angle of about 60 degrees, formed by a wire EDM process. The angle of about 60 degrees was selected for ease of manufacturing; however, computer modeling suggests that an angle of about 45 degrees may also be a particularly effective angle for this configuration. The number and size of the apertures 60 is based on a predetermined acceptable pressure drop and the predetermined mass of the heated second fluid to be added.

To reduce the overall length of the shell 50, the three pipes 46 are placed in a parallel configuration, a second pipe 46 positioned below a first pipe 46 and a third pipe 46 positioned below the second pipe 46, and connected by two 180 degree elbows 48. This configuration allows gravity to assist the flow through each of the elbows 48. Each elbow 48 includes a porous wall 62, particularly at the outer radius thereof.

In operation, a first fluid may enter the conduit 40 through an inlet 52 as a slurry comprising liquid methane and solid carbon dioxide at a temperature of about −218.6 F (about −139.2 C), a pressure of about 145 psia (about 1,000 kpa) and a mass flow rate of about 600 lbm/hr (about 272 kg/hr). A second fluid may enter the chamber 58 through the inlet 84 as gaseous methane at a temperature of about 250 F (about 121.1 C), a pressure of about 150 psia (about 1,034 kpa) and a mass flow rate of about 800 lbm/hr (about 362.9 kg/hr). The mixture of the first fluid and the second fluid is then directed through the outlet 54 of the conduit 40 as a solid carbon dioxide suspended in gaseous methane at a temperature of about −96.42 F (about −71.34 C) and a pressure of about 145 psia (about 1,000 kpa).

As the first fluid is conveyed through the conduit 40, the heat energy provided by the second fluid may be used to facilitate a phase change of the liquid methane of the first fluid to gaseous methane. As this transition occurs, the temperature of the first fluid may remain at about −230° F. (this temperature may vary depending upon the pressure of the fluid) until all of the liquid methane of the first fluid is converted to gaseous methane. The solid carbon dioxide of the first fluid may then be suspended in the combined gaseous methane of the first and second fluids, but will not begin to sublime until the temperature of the combined fluids has reached about −80° F. (this temperature may vary depending upon the pressure of the fluid environment). As the temperature required to sublime the carbon dioxide is higher than the vaporization temperature of the methane, the solid carbon dioxide will be suspended in gaseous methane while mixture of the first fluid and the second fluid exits the conduit 40.

In light of the above disclosure it will be appreciated that the apparatus and methods depicted and described herein enable the effective and efficient vaporization of a liquid within a fluid flow. The invention may further be useful for a variety of applications other than the specific examples provided. For example, the described apparatus and methods may be useful for the effective and efficient mixing, heating, cooling, and/or conveyance of fluids.

While the invention may be susceptible to various modifications and alternative forms, specific embodiments of which have been shown by way of example in the drawings and have been described in detail herein, it should be understood that the invention is not intended to be limited to the particular forms disclosed. Rather, the invention includes all modifications, equivalents, and alternatives falling within the scope of the invention as defined by the following appended claims and their legal equivalents. Additionally, features from different embodiments may be combined.

1. A vaporization chamber, comprising:
at least one conduit having an inlet at a first end, an outlet at a second end and a flow path therebetween;
a shell surrounding a portion of the at least one conduit and defining a chamber surrounding at least a portion of the at least one conduit; and
a plurality of discrete apertures positioned at longitudinal intervals in a wall of the at least one conduit, each discrete aperture of the plurality of discrete apertures sized and configured to direct a jet of fluid into the at least one conduit from the chamber.

2. The vaporization chamber of claim 1, wherein the plurality of discrete apertures is oriented to direct a jet of fluid at an acute angle with respect to a longitudinal axis of the at least one conduit.

3. The vaporization chamber of claim 1, wherein each discrete aperture of the plurality of discrete apertures is shaped as a slit.

4. The vaporization chamber of claim 1, wherein the at least one conduit comprises a metal pipe.

5. The vaporization chamber of claim 4, wherein the metal pipe comprises a stainless steel pipe.

6. The vaporization chamber of claim 5, wherein at least a portion of an interior of the stainless steel pipe is polished.

7. The vaporization chamber of claim 1, wherein the plurality of discrete apertures further comprises circumferentially spaced apertures.

8. The vaporization chamber of claim 7, wherein the circumferentially spaced apertures comprise apertures in at least one generally annular arrangement.

9. The vaporization chamber of claim 7, wherein the circumferentially spaced apertures comprise apertures in a helical arrangement.

10. The vaporization chamber of claim 1, wherein the at least one conduit further comprises at least one elbow.

11. The vaporization chamber of claim 10, wherein the at least one elbow comprises a porous wall.

12. The vaporization chamber of claim 1, wherein the inlet of the at least one conduit is coupled to an underflow outlet of a hydrocyclone.

13. The vaporization chamber of claim 12, wherein the outlet of the at least one conduit is coupled to a sublimation chamber.

14. A method of vaporizing a liquid, the method comprising:
directing a first fluid comprising a liquid into an inlet at a first end of a conduit;
directing jets of a second fluid into the conduit from a chamber surrounding the conduit through discrete apertures in a wall of the conduit;
vaporizing the liquid of the first fluid by transferring heat from the second fluid to the first fluid; and
directing a mixture comprising the first fluid and the second fluid through an outlet at a second end of the conduit.

15. The method of claim 14, wherein directing the jets of the second fluid into the conduit further comprises directing the jets of the second fluid into the conduit at a direction that opposes an average flow direction through the conduit.

16. The method of claim 14, wherein directing the first fluid into the inlet further comprises directing a first fluid comprising liquid methane and solid carbon dioxide into the inlet.

17. The method of claim 16, wherein directing jets of the second fluid into the conduit comprises directing jets of gaseous methane into the conduit.

18. The method of claim 17, wherein directing the mixture comprising the first fluid and the second fluid through the outlet at the second end of the conduit comprises directing gaseous methane and solid carbon dioxide through the outlet at the second end of the conduit.

19. The method of claim 14, further comprising directing the first fluid through at least one bend in the conduit.

20. The method of claim 14, wherein directing jets of the second fluid into the conduit comprises directing fan-shaped jets of the second fluid into the conduit.
